(19) United States
(12) Patent Application Publication
(10) Pub. No.: US 2010/0116119 A1
(43) Pub. Date: May 13, 2010

(54) METHOD FOR SEPARATING A COMPOSITE GLASS ASSEMBLY

(76) Inventor: John F. Bayne, Elmira, NY (US)

Correspondence Address: CORNING INCORPORATED, SP-TI-3-1, CORNING, NY, 14831, US

(21) Appl. No.: 12/267,721

(22) Filed: Nov. 10, 2008

(51) Int. Cl. B26D 3/08

(52) U.S. Cl. 83/880

(57) ABSTRACT

A method is disclosed for separating a composite glass assembly comprising a plurality of organic light emitting diode devices into separate OLED devices. In one embodiment the composite glass assembly comprises two glass plates rigidly joined by a brittle sealing material, such as a glass-based frit. The brittle sealing material is positioned in the form of a plurality of picture frame-like walls that, in conjunction with the first and second glass plates, form a hermetic seal around organic light emitting diodes that comprise each OLED device. The method includes separating the glass plates of the assembly on a support plate comprising a free space channel below a score line formed in one of the glass plates.

### BACKGROUND OF THE INVENTION

1. Field of the Invention

The present invention relates to a method for separating a composite glass assembly. More particularly, the present invention relates to a method for separating a plurality of photonic devices formed from master glass sheets into individual devices.

2. Technical Background

Photonic devices, such as organic light emitting diode devices, are often manufactured by forming multiple devices in a single assembly using large master (mother) sheets of glass. That is, the devices are encapsulated between two large glass sheets or plates to form a composite assembly, after which individual devices are cut from the composite assembly. Each device of the composite assembly includes a seal surrounding the organic light emitting diodes of the individual device that seals the top and bottom plates together, and protects the organic light emitting diodes disposed within, since some devices, particularly organic light emitting diodes, degrade in the presence of oxygen and moisture that can be found in the ambient atmosphere. The photonic devices may be sealed using an adhesive, e.g. epoxy, or more recently, using a glass frit that is heated to melt the frit and form the seal between the two plates.

Frit sealed devices exhibit certain advantages over adhesive-sealed devices, not least of which is the superior hermeticity afforded by the frit seal when compared to adhesive seals, and without the need for getters sealed within the device to scavenge contaminants. Thus, frit sealed devices are able to provide for a longer lived device that has been achievable with adhesive seals. Nevertheless, it has been found that when the separating out of individual frit sealed devices from the composite assembly is performed in a conventional manner such as routinely used for adhesive-sealed devices, a cantilevered lip may be formed along an edge of the cut plate. This has been found to be a particularly troublesome outcome for the first cut plate (e.g. the initial cuts)

### SUMMARY

Methods are disclosed for separating a composite glass assembly. The assembly may be, for example, an assembly of electroluminescent display devices, such as an assembly of organic light emitting diode display devices, or the assembly may be an assembly of electroluminescent lighting devices. Generally, the assembly is a composite of two thin glass plates rigidly connected by a sealing material that is separated into subcomponents or subassemblies by cleaving the parent assembly along score lines formed in a surface of at least one of the glass plates. Preferably, the sealing material is a brittle sealing material, such as a glass frit. In some embodiments, the parent assembly is comprised of substrates having a thickness of less than about 0.7 mm (e.g. 0.65 mm), but even thinner substrates may be employed. The distance separating the connected substrates may be less than about 20 μm, preferably less than about 18 μm. For example, the substrates may be separated by a mere 15 μm. The thinness of the glass plates, the extremely small spacing between the substrates, and the rigid, brittle nature of the seal between the substrates presents unique challenges to separating or dicing the assembly into individual devices suitable for their intended use.

In one embodiment, a method of separating a composite glass assembly is disclosed comprising providing a composite glass assembly, the assembly comprising a first glass plate, a second glass plate and at least two walls comprising an inorganic glass disposed between and rigidly connecting the first and second glass plates one to the other. The first glass plate is scored to form a score line on the first glass plate between the at least two walls, and supported on a support plate such that the first glass plate is disposed opposite the support plate, the support plate configured to provide a free space between the first glass plate and the support plate. A force is then applied against the second glass plate opposite the score line to separate the first glass plate along the score line without separating the second glass plate.

In another embodiment, a method of separating a composite glass assembly is described comprising providing a composite glass assembly, the assembly comprising a first glass plate, a second glass plate, a plurality of photonic devices disposed between the first and second glass plates and at least two connecting walls comprising a brittle material disposed between the first and second glass plates, the connecting walls rigidly connecting the first and second glass plates. The first glass plate is scored to form a score line on the first glass plate between the at least two connecting walls, and supported on a support plate such that the first glass plate is disposed opposite the support plate, the support plate configured to provide a free space between the first glass plate and the support plate. A force is then applied against the second glass plate opposite the score line to separate the first glass plate along the score line without separating the second glass plate.

The invention will be understood more easily and other objects, characteristics, details and advantages thereof will become more clearly apparent in the course of the following explanatory description, which is given, without in any way implying a limitation, with reference to the attached Figures. It is intended that all such additional systems, methods features and advantages be included within this description, be within the scope of the present invention, and be protected by the accompanying claims.

### BRIEF DESCRIPTION OF THE DRAWINGS

FIG. 1 is a cross sectional view of a portion of a glass plate that is separated according to prior art methods showing a characteristic lip or cantilever along the separated surfaces of the plate.

FIG. 2 is a top down view of an exemplary composite glass assembly comprising a plurality of electroluminescent devices according to an embodiment of the present invention.

FIG. 3 is a cross sectional edge view of the assembly of FIG. 2.

FIG. 4 is a cross sectional view of the assembly of FIG. 2 shown positioned on an apparatus for separating the assembly along a score line.

FIG. 5 is a partial cross sectional view of the composite glass assembly and separating apparatus of FIG. 4 illustrating the application of a force to separate the first glass plate.

FIG. 6 is a top down view of the components of FIG. 6 (shown without the breaker bar) placed on the support plate.

FIG. 7 is a close up cross sectional view of the scored glass plate at the score during the separating process depicted in FIG. 6 and illustrating the development of tension and compression in the plate.

### DETAILED DESCRIPTION

In the following detailed description, for purposes of explanation and not limitation, example embodiments disclosing specific details are set forth to provide a thorough understanding of the present invention. However, it will be apparent to one having ordinary skill in the art, having had the benefit of the present disclosure, that the present invention may be practiced in other embodiments that depart from the specific details disclosed herein. Moreover, descriptions of well-known devices, methods and materials may be omitted so as not to obscure the description of the present invention. Finally, wherever applicable, like reference numerals refer to like elements.

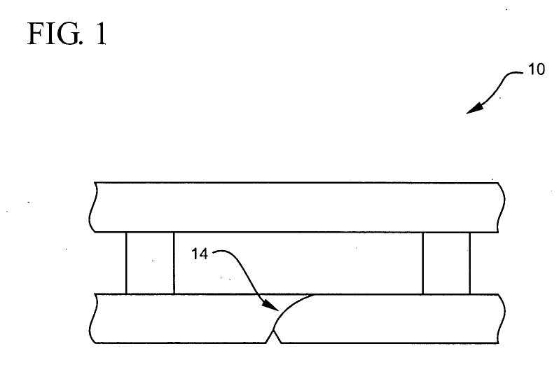

FIG. 1 illustrates a portion of an exemplary composite glass assembly 10. It has been found that when separating individual subcomponents (e.g. individual photonic devices) from a frit sealed composite glass assembly, such as an assembly that may comprise a plurality of photonic devices, a cleave (shown by line 12) through the first cut glass plate may deviate (curve away) from the perpendicular to the glass plate surface, thereby forming a lip 14 along the cut edge of the plate. This lip is commercially undesirable.

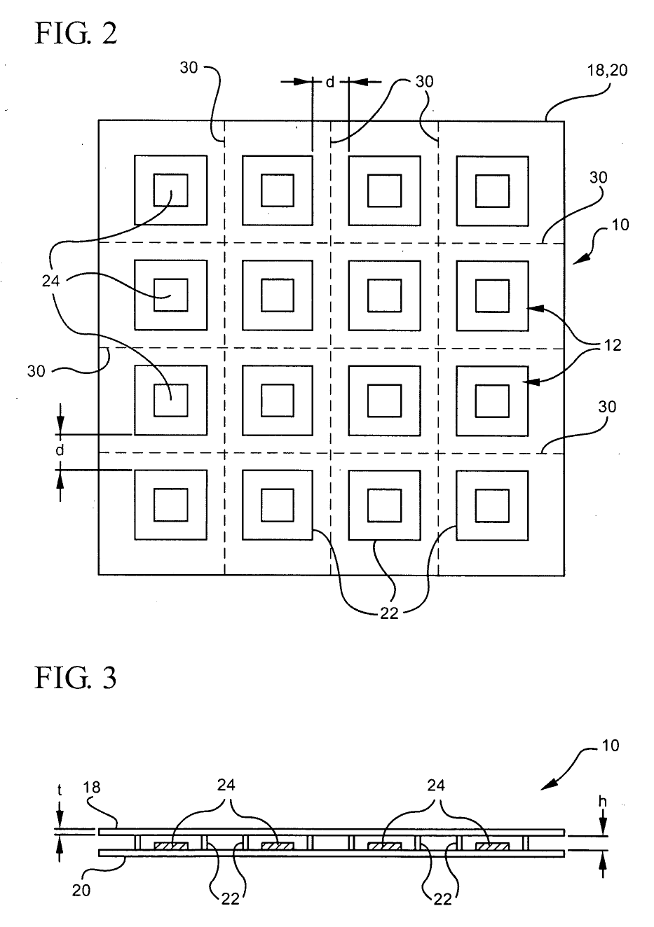

FIGS. 2 and 3 show respectively a top down view and a cross sectional side view of exemplary composite assembly 10 comprising a plurality of individual photonic devices 16 arrayed thereon. It is typical to array the individual devices in ordered rows and columns in a grid-like fashion. That is, the rows are preferably parallel to each other, and the columns are similarly parallel to each other. Composite assembly 10 comprises a first glass plate 18, a second glass plate 20 and a plurality of seals 22 disposed therebetween that connect and seal the first glass plate to the second glass plate. Glass plates 18 and 20 preferably have a thickness t equal to or less than about 1 mm, and more preferably less than or equal to about 0.7 mm. The height h of seals 22, that is the distance separating the inside surfaces of glass plates 18 and 20, is preferably between about 10 μm and 20 μm, more preferably between about 12 μm and 18 μm. For example, the height h of seals 22 may be about 15 μm.

A photonically active material 24 is preferably positioned within the resulting encapsulating pocket formed by a seal and the first and second glass plates. The encapsulated photonically active material is thereby protected from the ambient atmosphere surrounding the assembly. As used herein, photonic devices are devices that use light to perform an electro-optic function, and a photonically active material is a material that similarly employs light in a reaction by the material. For example, a photonically active material may produce an electric current and/or voltage in response to being exposed to light, such as in a photovoltaic device (e.g. solar cell), or a photonically active material may produce light in response to being supplied with an electric current and/or voltage. In the latter case, the photonically active material 24 may comprise one or more layers of an organic material and be included in an organic light emitting diode that in turn comprises an optical display such as a computer monitor or it may be used in a lighting panel.

Seals 22 are preferably formed from a glass-based frit, although the present invention may be applied to assemblies comprising other sealing materials, such as an epoxy adhesive or the like. For the purposes of further discussion and not limitation, glass based frit seals will be assumed.

The frit that connects and seals the first and second glass plates together is generally a composition that includes an inorganic glass comprising one or more metal oxides. A frit may be produced by first forming a glass having a composition appropriate for sealing together glass parts, then grinding the glass, such as by ball milling, to form a glass powder. The appropriateness of a particular frit glass may be based, for example, on the coefficient of thermal expansion of the frit glass, its softening or melting point, its composition relative to the composition of the parts to be sealed or the application of the sealed device, or any other factors that bear on the compatibility of the frit relative to the parts to be sealed or the application in which the assembly is to employed. The glass powder may be combined with a liquid vehicle for carrying the powder, such as an organic solvent, and include one or more binders to form a paste. Other ingredients may include inert fillers used to adjust the coefficient of thermal expansion (CTE) of the frit to be compatible with the glass plates to which it is sealed. For example, the CTE of the frit is often adjusted to be equal to or less than the CTEs of the glass plates. In some embodiments, the frit may be dispensed onto one plate, and then heated in a furnace for a time and at a temperature sufficient to burn off the vehicle and the binder in a process called pre-sintering that also consolidates and adheres the frit to the plate.

If, for example, the composite assembly comprises a plurality of organic light emitting diode devices, the organic light emitting diodes of individual OLED devices may be formed on the second (backplane) substrate plate. A plurality of frit walls may be dispensed onto the first (cover) substrate plate and the cover plate thereafter heated to pre-sinter the frit to the cover plate. The backplane and the cover are then brought together in overlying registration so that the organic light emitting diodes associated with each OLED device are surrounded by a corresponding frit wall. Afterward, the frit may be irradiated with a laser, preferably through one or both of the glass substrates, to melt the frit and form a seal between the glass plates that encircles the components (e.g. photonically active material) of the individual device. If a laser is used to melt the frit, the frit may comprise one or more constituents, such as transition metals, to improve the light absorption of the frit at the specific wavelength of the laser light. For example, vanadium (e.g. V₂O₅) is a strong absorber in the infrared region of the spectrum. A more detailed description of an exemplary frit sealing process may be found in U.S. Pat. No. 6,998,776 to Aitken et al, the contents of which are included herein in their entirety by reference.

It should be understood from the foregoing description that the frit seal comprises an inorganic glass. Thus, while a frit seal provides excellent hermeticity, it forms a rigid seal that exhibits also by its nature a degree of brittleness. Unlike adhesive seals, the frit seal does not undergo significant plastic deformation under stress, and may fracture if exposed to excessive levels of energy that may be imparted to the frit when attempting to cleave the assembly. Thus, care should be taken to reduce, to the extent possible, the amount of energy imparted to the assembly, and thus to the frit, when cleaving the assembly. That is, the amount of energy used should be sufficient to form a crack extending through the thickness of the substrate between the frit seals without damaging the seals. Without wishing to be held to any particular theory, it is believed that the rigid characteristics of the glass seals are responsible, at least in part, for the formation of a lip along the cleaved edge of the first cleaved glass plate of a composite glass assembly in conventional separating processes.

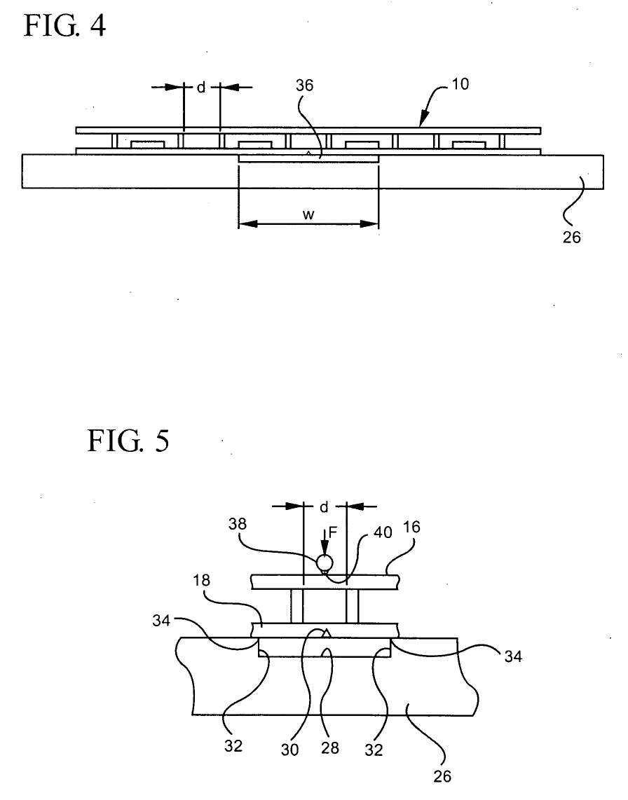

Shown in FIGS. 4 and 5 is an apparatus for separating individual photonic devices from a composite assembly comprising a plurality of photonic devices according to an embodiment of the present invention. The apparatus comprises a base plate 26 defining a channel 28 formed in a surface thereof Preferably, the channel comprises a width w that is at least two times the spacing d between adjacent frit seals on composite assembly 10. Typically, the frit seals are closed loops resembling picture frames (e.g. having a rectangular shape including an open interior portion and with substantially straight sides or walls).

To separate parent assembly 10 into subassemblies, a score is first formed on one side of the parent assembly along any one of a plurality of pre-determined score lines 30 (indicated by dashed lines in FIG. 2), for example along an outside surface of first substrate plate 18. The score may be formed using conventional mechanical scoring techniques, such as a conventional glass cutting wheel, a diamond scribe, a carbide scribe or the like. The scoring apparatus is used to form a partial vent crack in the glass along the score line, and which vent crack generally extends perpendicularly into the body or thickness of the glass, but does not extend completely through the glass. As can be appreciated, once the composite assembly has been cleaved (cut) along each of the score lines 30 (a similar set of cleaves are made on the opposite substrate along similar score lines), assembly 10 may be separated into individual devices 16.

Alternatively other methods as are known in the art could be used to form the vent along the score line, such as a laser scoring technique. In a laser scoring technique, a small flaw or crack is made at one edge of the glass, and a laser, such as a CO₂ laser, produces a laser beam that is traversed across the surface of the glass along a predetermined line extending from the initial flaw. At least a portion of the laser beam is absorbed by the glass, thereby heating the glass and inducing thermal stresses that cause the initial flaw to propagate along the score line. In some embodiments, the beam is closely followed by a jet of cooling fluid that increases the thermal stresses and extends the resultant vent crack into the glass.

Once a score is produced along a score line, the parent assembly may be placed on plate 26 with score line 30 facing downward toward plate 26 and further facing into channel 28. In accordance with the present embodiment, channel 28 is depicted as a rectangular depression having substantially vertical and parallel side walls 32. However, it should be noted that this is but one of many possible configurations. For example, the channel could be U-shaped, wherein the sides walls are curved. It is preferred, however, that the edge 32 of each side wall (where the side wall intersects the surface of the support plate), is parallel with the other side wall edge at least for the extent to which the composite glass assembly straddles the channel (i.e. the length of the score line 30).

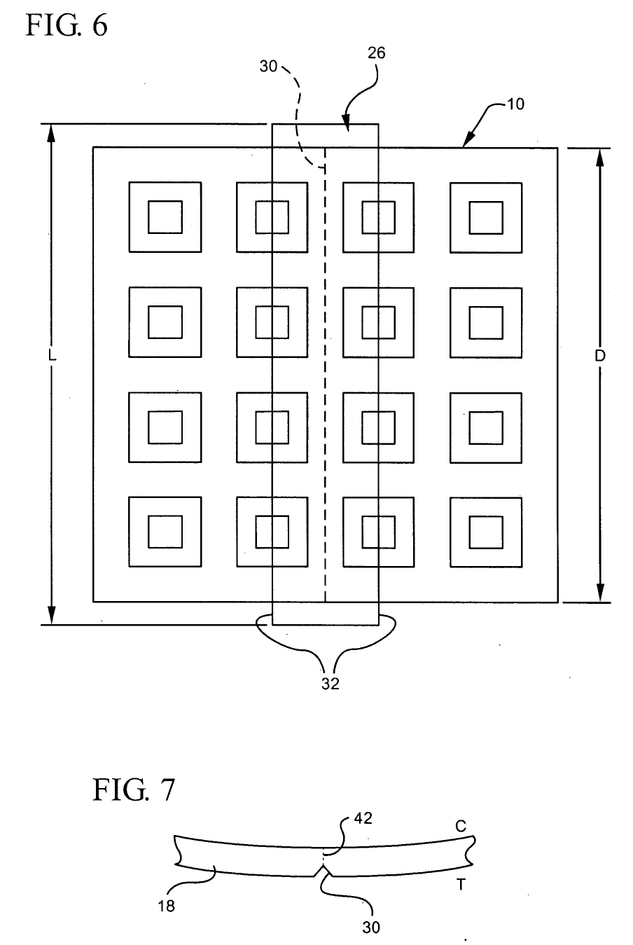

The preceding concept is depicted in FIGS. 5 and 6, wherein support plate 26 supports composite glass assembly 10 as previously described. Composite glass assembly 10 is generally rectangular in shape, with first and second glass plates being substantially rectangular and in at least partial registration which each other. As shown in FIG. 2, each score line 30 is preferably a straight line that extends from one edge of the scored glass plate to the opposite edge of the scored glass plate. For ease in description, the scored glass plate will be assumed to be first glass plate 18, with the understanding that the scored glass plate could be either one of the first or second glass plates. In accordance with the present embodiment, the length L of channel 28 is greater than the length D of score line 30.

Preferably, the composite glass assembly is positioned on support plate 26 such that score line 30 is generally equidistant between opposing edges 34 of channel 28. It should be understood however that precise alignment of the score line over channel 28 is not critical: a skew of several degrees from parallel, or an offset of a couple millimeters from a centerline between edges 32, 34 can be easily tolerated.

Once composite glass assembly 10 is positioned on support plate 26 as described above, breaker bar 38 may then be used to apply a force F to (e.g. second) glass plate 20 through breaker bar 38 such that flexing of the assembly results, and therefore flexing of the individual glass plates comprising the assembly. It is preferred that breaker bar 38 present close to a line contact to second glass plate 20. That is, it is preferred that breaker bar contact second glass plate 20 along a line (as opposed to surface contact). In certain embodiments, breaker bar 38 may comprise an optional resilient portion 40 that contacts glass plate 20. For example, breaker bar 38 may be a stiff bar that includes a rubber or similar resilient material that contacts the glass plate. The resilient material minimizes damage to the plates when contact is made. The applied force F against second substrate 20 causes the scored first glass plate 18 to flex downward, placing the scored side of first glass plate 18 in tension. This is illustrated simplistically in FIG. 7, wherein a portion of the first glass plate is depicted with a small curvature, creating a tension side T of the plate and a compression side C of the plate. The tensile stress formed at the tip of the crack formed during scoring causes the crack to propagate through the thickness of the first glass plate without deviating significantly from a perpendicular path (relative to the scored surface of the plate) and indicated by dotted line 42, as the crack traverses from the tension side to the compression side of the plate being broken. It is believed that providing a free space (e.g. free space 36 in FIG. 5) beneath the score line allows for localized flexure of the glass plates to generate sufficient tensile stress from a smaller amount of applied to fracture and separate the plate than would otherwise be required in a prior art method (typically supporting the assembly on a flat surface and applying a force proximate the score line). FIG. 7 is shown without second plate 20 and support plate 26 for clarity.

It should be emphasized that the above-described embodiments of the present invention, particularly any “preferred” embodiments, are merely possible examples of implementations, merely set forth for a clear understanding of the principles of the invention. Many variations and modifications may be made to the above-described embodiments of the invention without departing substantially from the spirit and principles of the invention. For example, as described previously, the present invention may also be applied to assemblies sealed with an adhesive, such as an epoxy. Moreover, while the present description has been presented in the context of a frit seal, a substantially glass seal can be formed in other ways. For example, pre-formed glass members (e.g. glass bars or glass “gaskets”) may be positioned between the substrates and heated to soften the glass members and adhering them to the substrates to connect and seal the substrates. All such modifications and variations are intended to be included herein within the scope of this disclosure and the present invention and protected by the following claims.

What is claimed is:

1. A method of separating a composite glass assembly comprising:
providing a composite glass assembly, the assembly comprising
a first glass plate;
a second glass plate; and
at least two walls comprising an inorganic glass disposed between and rigidly connecting the first and second glass plates one to the other;
scoring the first glass plate to form a score line on the first glass plate between the at least two walls;
supporting the assembly on a support plate such that the first glass plate is disposed opposite the support plate, the support plate configured to provide a free space between the first glass plate and the support plate; and
applying a force against the second glass plate opposite the score line to separate the first glass plate along the score line without separating the second glass plate.

2. The method according to claim 1, wherein the support plate comprises a channel formed within the plate

3. The method according to claim 2, wherein the channel comprises at least two side walls separated by a distance equal to or less than 2 times a distance d between the two side walls.

4. The method according to claim 1, wherein the composite glass assembly comprises a plurality of photonic devices.

5. The method according to claim 2, wherein the assembly is positioned on the support plate such that the score line is disposed substantially equidistant between two edges of the channel along a length of the score line.

6. The method according to claim 4 wherein the photonic devices comprises an organic material.

7. The method according to claim 4 wherein the photonic devices are photovoltaic devices, display devices or lighting devices.

8. A method of separating a composite glass assembly comprising:
providing a composite glass assembly, the assembly comprising:
a first glass plate;
a second glass plate;
a plurality of photonic devices disposed between the first and second glass plates; and
at least two connecting walls comprising a brittle material disposed between the first and second glass plates, the connecting walls rigidly connecting the first and second glass plates;
scoring the first glass plate to form a score line on the first glass plate between the at least two connecting walls;
supporting the composite glass assembly on a support plate such that the first glass plate is disposed opposite the support plate, the support plate configured to provide a free space between the first glass plate and the support plate; and
applying a force against the second glass plate opposite the score line to separate the first glass plate along the score line without separating the second glass plate.

9. The method according to claim 8, wherein the composite glass assembly is positioned on the support plate such that the score line is disposed over the free space.

10. The method according to claim 8, wherein the at least two connecting walls were formed from a glass frit.

11. The method according to claim 8, wherein the at least two connecting walls comprise an inorganic glass.

12. The method according to claim 8 wherein the photonic devices comprise an organic material.

13. The method according to claim 12 wherein the photonic devices comprise organic light emitting diodes

14. The method according to claim 8 wherein the photonic devices are photovoltaic devices, display devices or lighting devices.
